(19) United States
(12) Patent Application Publication
(10) Pub. No.: US 2012/0040061 A1
(43) Pub. Date: Feb. 16, 2012

(54) Process For Smoking Food

(76) Inventor: Stephen J. Caputi, Lauderhill, FL (US)

(21) Appl. No.: 12/854,380

(22) Filed: Aug. 11, 2010

(51) Int. Cl. A23B 4/044

(52) U.S. Cl. 426/235

(57) ABSTRACT

Smoking food items in a cold environment is carried out by utilizing an atmospherically sealed housing, in which at least one food item is placed, and subjecting the atmospherically sealed housing to a vacuum. Subsequently, the vacuum is partially released to draw in smoke from at least one other container that is connected to the atmospherically sealed housing. As the smoke is being drawn in from the other container it is being infused into the food item. The food item(s) is then rotated in the partial vacuum for a specific, but variable, amount of time, depending on the food item and the degree of flavor desired. The cycle may be repeated until the desired flavor is achieved. Once the desired flavor is achieved, the vacuum is completely released and the food item is removed and either cooked or stored for consumption at a later time.

### FIELD OF THE INVENTION

The present invention relates to a process for preparing smoked food items.

### BACKGROUND OF THE INVENTION

Meat, poultry, fish and other food items have typically been flavored via smoking through the use of smokehouse-type systems, barbecue grilling, and marinade injection. Smokehouse systems commonly involve the food items being placed in cages or on racks, which are then placed in a heated smoking chamber. In the smoking chamber, smoke circulates up through the center of the chamber; thereby flavoring the food item(s). This process typically involves a heat-up cycle wherein moisture is removed from the surfaces of the food items and a smoking cycle. These smokehouse operations have several shortcomings. For example, batch-type smoking operations for poultry items require approximately five to seven hours or more. Additionally, these slow smoking processes can sometimes impart an extremely dark color and/or overpowering smoke flavor to the food items and because this smoking process does not provide desirably uniform temperature and smoke profiles, it will sometimes cause substantial variations in the nature and quality of the products produced.

Barbecuing, grilling and the use of flavor injectors are additional methods utilized to flavor food items. Barbecuing flavors the food, whether poultry, meat, or fish, only after the food has been cooking for a long period of time at low heat and sitting in sauce, which typically comprises grease, oil, and other unhealthy substances. Additionally, since the food is cooked at low heat in a barbecue for long periods of time, it becomes a great environment for bacteria to grow. Whereas, using flavor injectors to impart flavoring into food requires that the food be thawed and not frozen. The constant thawing and freezing of food will cause the food to lose taste and will also compromise the integrity of the cellular structure, causing the food item to taste mushy, soggy, and to lose mouth feel. Whether utilizing traditional smokehouse systems, barbecue, or flavor injectors to impart flavor into a food item such methods are not only inefficient and unhealthy, but also decrease the storage time of flavored food items.

Therefore, what is needed is a process to flavor food items that not only is healthier, more efficient, and enhances the flavor of the food, but also increases the storage time and shelf life of flavored food items, with superior sanitary conditions.

The present invention will be more fully understood and appreciated from the following detailed description.

### DETAILED DESCRIPTION OF THE PREFERRED EMBODIMENT

The use of heat, whether by traditional smokehouses, grilling, or barbecue, results in product loss because the cell structure degrades. Additionally, these methods not only require a great deal of time, remove moisture and, many times, flavor, but also cook the food. Once the food items have been cooked, the food items must be eaten immediately or within a very short period of time after cooking because cooked food is much more susceptible to the growth of bacteria than frozen food. Further, cooked food that is held in a warm environment, for example, room temperature, promotes the growth of bacteria and, in turn, food borne illnesses. If the food items are being flavored through grilling or barbecue, many times the food items have to be cooked for long periods of time at low heat, while sitting in sauce, which typically comprises grease, fat, and other unhealthy substances. Similarly, to utilize a flavor injector, the food must be thawed and, therefore, exposed to the environment and the bacteria in that environment.

In addition to the efficiency, sanitary and health concerns discussed above, the cooking of food not only removes moisture, but also dramatically decreases the amount of time in which the flavored food can be stored or the amount of time allotted to distribute the flavored food before it must be consumed. While the use of flavor injectors does not require the food item to be cooked, it does require the food item to be thawed and maintained at room temperature. The repeated thawing and freezing of food to allow a person to use a flavor injector will quickly cause the food to lose taste and may even result in freezer burn. However, since Applicant's invention flavors the food by using a vacuum to inject the smoke in the absence of heat, the food is not cooked.

The process of the present invention comprises placing at least one food item, whether it be meat, poultry, fish, or some other food item into an atmospherically sealed housing; sealing the atmospherically sealed housing; subjecting the atmospherically sealed housing to a vacuum through the use of a vacuum pump; drawing in the smoke from at least one separate container by partially releasing the vacuum in the atmospherically sealed housing. Once the desired pressure is achieved, the valve is closed and the food item is allowed to remain in the atmospherically sealed housing for a short period of time until the desired flavor has been achieved. The amount of pressure left in the vacuum after the pressure valve is partially released can vary depending on the desired final product For example, depending on the desired final product the pressure in the atmospherically sealed housing can be released from 25% to 75%. Once the smoke is drawn into the atmospherically sealed housing, the food items are rotated inside the atmospherically sealed housing for a specific amount of time. The amount of time in which the food item is left rotating in the atmospherically sealed housing varies depending on the desired final product. Once the food item has been rotated inside the atmospherically sealed housing for the desired amount of time, the vacuum is fully released and the food item is removed. The process can always be repeated depending on the amount of flavor imparted by the smoke that is desired.

The vacuum, utilized in the instant process, creates a cold environment. The cold environment not only prevents the food items from degrading, as it does when it is cooked, but also, reduces, if not significantly inhibits the growth of bacteria and food borne illnesses. A vacuum will also cause the cells in the food item(s) to expand. By partially releasing the vacuum, the smoke will be drawn in from another chamber and infused into the food product while the cells are expanded by the vacuum; thereby, enhancing the cooked finished product. Since the smoke is immediately infused into the food item through the expanded cells, the flavor of the food product is not only significantly enhanced, but the amount of time necessary to smoke the food item is dramatically reduced from many hours to minutes. Further, since the food item is flavored through the infusion of smoke it does not have to sit is sauces comprising fat, grease, oil, and other unhealthy substances; thereby producing a healthier, better quality, lower fat product.

Additionally, this process will also maintain the moisture of a food item. All food items contain water and as the item is cooked or heated the water is evaporated. Once the food item is ready for consumption, whatever moisture was in the food item has been partially or completely evaporated; thereby drying out the food item. By smoking the food item in a cold environment, prior to cooking or preparing the food item, the food item will have the same amount of moisture as it did initially since the moisture will not be evaporated, which will result in a superior quality product.

Since the food item is still raw after the smoking process, the food item can be cooked, refrigerated, or frozen until it is ready to be eaten. The ability to cook the food immediately after the smoking process, or to refrigerate the food item, or to store the food item once it is frozen will eliminate the waste normally associated with the traditional smoking/barbecuing/grilling methods described above. This process also allows an unlimited variety of food groups to be smoked that were previously impractical or unaffordable to smoke. For example, lobster tails (or tenderloins, lamb racks, other expensive specialty game meats, cheeses, etc.) could be smoked in a vacuum, vacuum sealed, and refrigerated for weeks before the final preparation and service. Conversely, with the traditional smoking methods that would cook the food item, if food item was not served immediately; it would be lost. Further, since the food item is smoked in a cold environment, the food item can be frozen immediately without the effects caused by thawing and freezing, associated with using a traditional flavor injector. This allows the flavored food to be stored for longer periods of time.

What is claimed is:

1. A process for smoking food which comprises:
(a) placing at least one food item in an atmospherically sealed housing,
(b) subjecting said atmospherically sealed housing to a vacuum, and
(c) drawing in smoke from at least one container.

2. The method of claim 1 wherein drawing in flavor comprises releasing the vacuum in said atmospherically sealed housing.

3. The method of claim 1 wherein said flavor comprises smoke.

4. The method of claim 1 wherein said food item is rotated in said atmospherically sealed housing.

5. A process for smoking food which comprises:
(a) placing at least one food item in an atmospherically sealed housing,
(a) subjecting said atmospherically sealed housing to a vacuum,
(b) releasing the vacuum, and
(c) drawing in smoke from at least one container.

6. The method of claim 5 wherein said food item is rotated in said atmospherically sealed housing.

7. A process for smoking food which comprises:
(a) placing at least one food item in an atmospherically sealed housing,
(b) subjecting said atmospherically sealed housing to a vacuum,
(c) releasing said vacuum,
(d) drawing in smoke from at least one container into said atmospherically sealed housing,
(e) allowing said food item to remain in the partial vacuum,
(f) releasing vacuum, and
(g) removing food item.
